(19) United States
(12) Patent Application Publication
(10) Pub. No.: US 2005/0228097 A1
(43) Pub. Date: Oct. 13, 2005

(54) Thermally conductive compositions and methods of making thereof

(75) Inventor: Hong Zhong, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 10/814,445

(22) Filed: Mar. 30, 2004

(51) Int. Cl. C08K 3/18; C08K 3/08

(52) U.S. Cl. 524/430; 524/439

(57) ABSTRACT

A composition comprising at least one liquid metal; at least one electrically insulating solid filler comprising thermally conducting materials; at least one curable resin; is provided. The composition is thermally conducting and electrically insulating. A method of making and using such a composition is also provided.

### BACKGROUND OF INVENTION

This invention relates to thermally conductive compositions that have initial low viscosity and after curing, high bulk thermal conductivity. More particularly, the invention relates to compositions and methods of preparing compositions useful as thermosets exhibiting high thermal conductivity and electrically insulating properties.

Thermal interface materials are particularly important in thermal management systems where a large amount of power is either generated or consumed. For instance, in the microelectronics industry, the drive for increasingly higher processing speed results in more heat generated per chip, and miniaturization results in a higher heat flux per unit area. The resulting high temperature often leads to mechanical stress, loss in performance and failure of electronic components due to CTE (coefficient of thermal expansion) mismatch. Most devices perform to rated specifications only within a narrow temperature range. Hence, efficient heat removal and heat transfer is a critical part in device design.

Thermal management is typically achieved by use of a heat dissipating component, such as a heat spreader, heat sink, lid, heat pipe, or any other designs and constructions known to those skilled in the art. Such heat dissipating components are used to conduct heat away from high temperature areas in an electrical system. A heat dissipating unit is a structure formed from a high thermal conductivity material (e.g. copper, aluminum, silicon carbide, metal alloys, polymer composites and ceramic composites) that is mechanically coupled to a heat generating unit to aid in heat removal. In a relatively simple form, a dissipating unit can include a piece of metal (e.g. aluminum or copper) that is in contact with the heat generating unit. Heat from the heat generating unit flows into the heat dissipating unit through the mechanical interface between the units.

In a typical electronic package, a heat dissipating unit is mechanically coupled to the heat producing component during operation by positioning a flat surface of the heat dissipating unit against a flat surface of the heat generating component and holding the heat dissipating unit in place using some form of adhesive or fastener. However, when two solid surfaces are brought together, e.g. the back side of a flip chip and one surface of the heat spreader, rarely will the surfaces be perfectly planar or smooth, so air gaps will generally exist between the surfaces. As is generally known, the existence of air gaps between two opposing surfaces reduces the ability to transfer heat through the interface between the surfaces. Thus, these air gaps reduce the effectiveness and value of the heat dissipating unit as a thermal management device. Direct surface-to-surface, or metal-to-metal contact without a thermal interface material leads to high thermal impedance and limited heat conduction capability.

To overcome this problem, a thermally conductive, mechanically compliant interface material is typically used to fill the gaps and to interconnect the two surfaces. Thermally conductive adhesives, gels, greases, phase change materials and pads or films carrying highly thermally conductive solid fillers have been devised for this purpose. For example, silver-filled silicones or epoxies are used as heat sink adhesives. Alumina or boron-nitride filled thermal interface materials are also known in the art.

Currently, one method for connecting heat dissipation devices such as heat sinks to heat generating devices such as dies is by dispensing a filled matrix between the interconnecting surfaces and curing it in situ. This approach requires that the uncured material have a viscosity low enough for the material to be forced through an orifice for rapid manufacture. However, the effective thermal conductivity depends on the extent that the fillers are in contact with each other as well as with the connecting surfaces; high thermal conductivities are only achieved at high filler loadings. At this stage, the thermal interface material may be too viscous to process and dispense.

One attempt to increase the filler-filler and filler-surface contact has been directed to highly thermally conductive particulates, such as copper, coated with low-melting metal such as tin, dispersed in a thermoplastic matrix with a solvent, acid and fluxing agent per need. The resulting paste has been used to connect two thermally conductive surfaces e.g., a chip and a substrate pad. While a fusible solder approach provides better particulate-particulate and particulate-surface interactions, certain limitations emerge. For instances, re-solidified solder is prone to deformation and fatigue. The method employs a flux agent that may raise environmental concerns. Further, the method is not particularly suited to wetting non-metallic surfaces.

A similar approach has been the use of liquid metal coated or bridged particle clusters Liquid metal has also been used as thermal and electrical contacts for heat-generating semiconductor devices. While liquid metals mitigate mechanical stresses between the device and the adhered members and enhance thermal conductivity, their tendency to form alloys or amalgams with other metals and their chemical reactivity with oxygen and moisture in air renders their long-term performance unacceptable. To alleviate the problem, liquid metals and their alloys or liquid-metal coated ceramic clusters have been dispersed in silicone oil to form an emulsion or a thermal paste. Thermal interface materials composed of curable or solidifiable compositions containing liquid metals or liquid metals and solid particulates have also been reported; however, such materials are electrically as well as thermally conductive, which are not desirable for many microelectronics applications. Methods have been described to circumvent the electrical conduction problem by hardening a polymer matrix prior to bringing two mating surfaces close together such that no continuous conductive bridges between the two surfaces are formed. While this provides electrical isolation between the two surfaces, the discontinuity also lowers the effectiveness of heat transfer.

Therefore, what is needed is a material composition having thermally conducting and electrically insulating properties, and when applied between heat generating and heat dissipating devices, such properties do not degrade over time. What is also needed is a low viscosity material composition to facilitate formation over various device geometries and architectures. Further, a method for making such material compositions and the curing and hardening of the material composition in situ is needed.

### BRIEF DESCRIPTION OF THE INVENTION

The present invention meets these and other needs by providing a material composition that is thermally conducting and electrically insulating. By curing or hardening the composition, the composition integrity as well as thermal, electrical and mechanical properties are retained over long periods of time. A method for making said composition is also provided in the present invention.

Accordingly, one aspect of the invention is a composition comprising a liquid metal, an insulating solid filler comprising thermally conducting materials, and a curable or hardenable resin. A second aspect of the invention is to provide a method for preparing the composition described above. A third aspect of the invention is an electronic device, or component comprising the thermal interface composition described above.

These and other aspects, advantages, and salient features of the present invention will become apparent from the following detailed description, and the appended claims.

### BRIEF DESCRIPTION OF THE DRAWINGS

FIG. 1 is a schematic representation of an electrical component in accordance with the present invention.

FIG. 2 is a cross-section view of a thermally conductive, electrically insulating thermal interface material.

### DETAILED DESCRIPTION OF THE INVENTION

The present disclosure provides a liquid metal composition having thermally conductive and electrically insulating properties. The composition is thermally conducting and electrically insulating and is a dispensable blend at the time of application that hardens on heating. In some embodiments, the composition is an adhesive. The liquid metal composition comprises at least one liquid metal, an electrically insulating solid filler comprising thermally conducting materials, and a curable resin. The composition may further comprise an adhesion promoter and a catalyst.

For a material composition that is thermally conducting and electrically insulating, the liquid metal acts as a bridge between two insulating filler particles and thermally conducts heat from particle to particle across the composition. Accordingly, heat transfer is facilitated. It is hence desired that the amount of liquid metal be sufficient to provide additional continuous heat transport pathways across the insulating filler particles and provide a rapid transport of heat. At the same time, the amount of liquid metal should not be excessive as to provide a continuous metallic contact across the composition that would make the composition electrically conducting. It is hence desirable to choose the amount of liquid metal such that a high thermal conductivity and a low electrical conductivity result. Typically, the composition includes, for each 100 parts by weight of resin, about 10 to about 1000 parts by weight of liquid metal, preferably about 100-600 parts by weight, or any range or combination of ranges therebetween. The composition further includes a solid insulating filler in an amount of about 200 to about 1100 parts by weight, and preferably about 400-900 parts by weight, or any range or combination of ranges therebetween. The incorporation of liquid metals into the composition improves thermal performance, or the achievement of high thermal conductivity of cured products while maintaining usable viscosity and processibility of uncured compositions.

By liquid metal is meant any metal that is in a liquid state at or about room temperature, or in the range of about −10° C. to about 35° C. Accordingly, in the present invention, any liquid metal that has a free flow may be used and includes, but is not limited to, low viscosity, freely flowing liquid metals and alloys such as gallium, indium, mercury, metallic glasses, their alloys and combinations thereof. Preferably, the liquid metal is liquid gallium, its alloys, or combinations thereof. The liquid metal wets the particulate surface and provides a conduit for heat transfer from one insulating particle to another.

Since various properties of liquids and liquid metals depend upon their density and surface tension, it follows that dense liquid metals, such as mercury, would comprise a lower volume distribution as compared to liquid metals of lower density such as gallium and gallium alloys. In addition to its lower density, when compared to mercury, gallium and gallium alloys have better wetting and surface tension characteristics that provide for easier distribution of the liquid metal phase within the composition.

The solid, or particulate, fillers are preferably thermally conductive but electrically insulating materials, and can be reinforcing or non-reinforcing. Further, the fillers can be micron-sized, sub-micron-sized, nano-sized, or a combination thereof.

The solid filler is preferably electrically insulating and comprises any insulator in particulate form, such as but not limited to, diamonds, graphite, carbon nanotubes, metal oxides (e.g., zinc oxide, aluminum oxide, magnesium oxide, titanium dioxide, zirconium oxide, chromium oxide, or iron oxide), metal hydroxides (e.g., aluminum hydroxides), metal oxy-hydroxides (e.g., bohemites), metal nitrides (e.g., boron nitride, aluminum nitride), metal nitrides with oxide coatings (e.g. silica coated aluminum nitride), metal particles or ceramic particles with an insulating coating (e.g., glass coated silver particles, alumina-coated silver particles, or palmic acid coated aluminum particles) and combinations and mixtures thereof. Additional fillers include fumed silica, fused silica, finely divided quartz powder, amorphous silicas, carbon black, silicone carbide, aluminum hydrates, and mixtures and combinations thereof.

When present, the solid filler is typically present in a range between about 10 weight % and about 92 weight %, or any range, or set of ranges therebetween, based on the weight of the total final composition. Preferably, the filler is present in a range between about 55 weight % and about 92 weight %, based on the weight of the total final composition.

The selection of the filler size is established in order to achieve improved in-device thermal performance. The average particle size is typically within the range of about 0.01 to about 100 microns, preferably about 0.01 to about 50 microns, and more preferably about 0.01 to about 25 microns. The maximum particle size in the formulation is preferably between 0.1-1.0 times that of the desired bond line thickness, so that a balance can be achieved to minimize the resin-particle interfaces while still maintaining the desired bond line thicknesses. The desired bond line thickness is between 0.01 mils to 5 mils, with a range between 0.01 to 2 mils being especially preferred.

In the present disclosure, the liquid metal and electrically insulating solid fillers are present in a weight ratio of about 2:1 to about 1:10. The combination of liquid metal and solid filler is present in the composition in an amount of about 20 to about 95 weight percent, preferably about 60 to about 95 weight percent. The liquid metal and solid fillers are blended with a curable resin, and optionally an adhesion promoter and a catalyst. Preferably, a high speeder mixer or a homogenizer is to be used during the mixing to obtain a homogeneous mixture and to minimize beading of the liquid metal phase. Additionally, the fillers may be further treated prior to or during mixing. Filler treatments include, but are not limited to, ball-milling, jet-milling, chemical or physical coating or capping via procedures including chemical treatment such as treatments with silazanes, silanols, silane or siloxane compounds or polymers containing alkoxy, hydroxy or Si—H groups and any other commonly used filler-treatment reagents, and any other procedures commonly adopted by those skilled in the art. The final formulation can be hand-mixed or mixed by standard mixing equipment such as speedmixer, blender, dough mixers, charge can mixers, planetary mixers, twin screw extruders, two or three roll mills and the like. The blending of the formulations can be performed in batch, continuous, or semi-continuous mode by any means used by those skilled in the art. It is preferred that the blended formulation is a homogenous mixture that does not bead.

Using fillers in accordance with the present disclosure provides lower thermal resistance while maintaining sufficiently low viscosities to allow easy processing and which will flow as necessary for preparation of electronic devices, especially flip-chip devices.

The curable resin may be a curable or thermosetting resin, including but not limited to a silicone resin, epoxy resin, acryloxy resin, or any combination thereof. The composition is a dispensable formulation at mixing that hardens to an immobilized solid upon curing. The final properties of thermal conductivity and electrical insulation are obtained on curing. In some embodiments of the present invention, curing is facilitated at particular temperatures. Preferably, resins are chosen such that the curing temperature is about 10° C. to about 200° C.

The curable resin can be any polymeric material. Suitable organic curable resins include, but are not limited to, polydimethylsiloxane resins, epoxy resins, acrylate resins, other organo-functionalized polysiloxane resins, polyimide resins, fluorocarbon resins, benzocyclobutene resins, fluorinated polyallyl ethers, polyamide resins, polyimidoamide resins, phenol cresol resins, aromatic polyester resins, polyphenylene ether (PPE) resins, bismaleimide triazine resins, fluororesins, mixtures thereof and any other polymeric systems known to those skilled in the art. (For common polymers, see “Polymer Handbook: Branduf, J.; Immergut, E. H; Grulke, Eric A; Wiley Interscience Publication, New York, 4^{th} ed.(1999); “Polymer Data Handbook Mark, James Oxford University Press, New York (1999)). Resins may also include hardenable thermoplastics.

Preferred curable thermoset matrices are acrylate resins, epoxy resins, polydimethyl siloxane resins, other organo-functionalized polysiloxane resins that can form cross-linking networks via free radical polymerization, atom transfer, radical polymerization ring-opening polymerization, ring-opening metathesis polymerization, anionic polymerization, cationic polymerization or any other method known to those skilled in the art, and mixtures thereof. Suitable curable silicone resins include, for example, the addition curable and condensation curable matrices as described in “Chemistry and Technology of Silicone”, Noll, W.; Academic Press 1968. Where the polymer matrix is not a curable polymer, the resulting thermal interface composition can be formulated as a gel, grease or phase change materials that can hold components together during fabrication and thermal transfer during operation of the invention.

In another embodiment, the curable resin can be an organic-inorganic hybrid matrix. Hybrid matrices include any polymers that contain chemically bound main group metal elements (e.g., aluminum, magnesium, gallium, indium), main group semi-metal elements (e.g. boron, germanium, arsenic, antimony), phosphorous, selenium, transition metal elements (e.g., platinum, palladium, gold, silver, copper, zinc, zirconium, titanium, ruthenium, lanthanum, etc.) or inorganic clusters (which include, but are not limited to, polyhedral oligomeric silsesquioxanes, nano metal oxides, nano silicon oxides, nano metal particles coated with metal oxides, and nano metal particles.) For typical examples and methods of forming inorganic-organic hybrids, see reviews such as “Hybrid Organic Inorganic Materials—in Search of Synergic Activity” by Pedro Gomez-Romero, Advanced Materials, 2001, Vol. 13, No. 3, pp. 163-174; “Inorganic Clusters in Organic Polymers and the Use of Polyfunctional Inorganic Compounds as Polymerization Initiators” by Guido Kickelbick and Ulrich Schubert, Monatshefte fur Chemie, 2001, Vol. 132, pp. 13-30; “Synthesis and Application of Inorganic/Organic Composite Materials”, by Helmut Schmidt, Macromolecular Symposia, 1996, Vol. 101, pp. 333-342; and “Synthesis of Nanocomposite Organic/Inorganic Hybrid Materials Using Controlled/‘Living’ Radical Polymerization” by Jeffrey Pyun and Krzysztof Matyjaszewski, Chemistry of Materials, 2001, Vol. 13, pp. 3436-3448. As used herein, “chemically bound” refers to bonding through a covalent bond, an ionic interaction, an iono-covalent bond, a dative bond or a hydrogen bond. Organic-inorganic hybrid polymeric matrices may refer to, but are not limited to, co-polymerization products between organic monomers, oligomers or polymers that contain polymerizable groups such as alkenyl, allyl, Si—H, acrylate, methacrylate, styrenic, isocyanate, epoxide and other common groups known to those skilled in the art, and inorganic clusters or organometallic compounds containing polymerizable groups. For example, the copolymerization product between an acrylate or a methacrylate and a metal acrylate or methacrylate compound is an organic-inorganic hybrid polymeric matrix. The copolymerization product between an epoxide and an epoxide-functionalized inorganic cluster is also considered an inorganic-organic hybrid polymer. The homo-polymerization products of organo-functionalized inorganic clusters or organometallic compounds, or the copolymerization products among different organo-functionalized inorganic clusters or organometallic compounds, are also considered organic-inorganic hybrid matrices. Organic-inorganic hybrid matrices also include cases where the inorganic cluster or organometallic compound has no polymerizable functional groups, but can become part of the polymer network through its surface OH or other functional groups.

The composition of the present invention may further include an adhesion promoter. An adhesion promoter may not only facilitate improved chemical interaction between precursors within the composition such as an increased compatibility among the liquid metal-filler-curable resin and other additives, but also improve cured composition's adhesion to the substrate. The adhesion promoters are present in an amount of from about 0 weight percent and about 5 weight percent, preferably, from about 0.01 weight percent and about 5 weight percent, more preferably about 0.01 to about 2 weight percent of the total final formulation, or any range or combination of ranges therebetween.

Adhesion promoters that can be employed include alkoxy- or aryloxysilanes such as γ-aminopropyltrimethoxysilane, 3-glycidoxypropyltrimethoxysilane and bis(trimethoxysilylpropyl)fumarate, or alkoxy- or aryloxysiloxanes such as tetracyclosiloxanes modified with acryloxytrimethoxysilyl or methacryloxypropyltrimethoxysilyl functional groups. They may also include, but are not limited to, silanols, oligosiloxanes containing an alkoxy silyl functional group, oligosiloxanes containing an aryloxysilyl functional group, polysiloxanes containing an alkoxy silyl functional group, oligosiloxanes containing a hydroxyl functional group, polysiloxanes containing an aryloxysilyl functional group, polysiloxanes containing a hydroxyl functional group, cyclosiloxanes containing an alkoxy silyl functional group, cyclosiloxanes containing an aryloxysilyl functional group, cyclosiloxanes containing a hydroxyl functional group, titanates, trialkoxy aluminum, tetraalkoxysilanes, isocyanurates, and mixtures, and combinations thereof.

The composition may also further contain at least one catalyst. The catalyst is selected from any group of catalysts compatible with the curable resin utilized in the present invention. Where epoxy resins are utilized, hardeners such as carboxylic acid-anhydride curing agents and an organic compound containing hydroxyl moiety can be added as optional reagents with the curing catalyst. For epoxy resins, exemplary anhydride curing agents typically include methylhexahydrophthalic anhydride, 1,2-cyclohexanedicarboxylic anhydride, bicyclo[2.2.1]hept-5-ene-2,3-dicarboxylic anhydride, methylbicyclo[2.2.1]hept-5-ene-2,3-dicarboxylic anhydride, phthalic anhydride, pyromellitic dianhydride, hexahydrophthalic anhydride, dodecenylsuccinic anhydride, dichloromaleic anhydride, chlorendic anhydride, tetrachlorophthalic anhydride, and the like. Combinations comprising at least two anhydride curing agents may also be used. Illustrative examples are described in “Chemistry and Technology of the Epoxy Resins” B. Ellis (Ed.) Chapman Hall, New York, 1993 and in “Epoxy Resins Chemistry and Technology”, edited by C. A. May, Marcel Dekker, New York, 2nd edition, 1988. Additional catalysts include amines, alkyl-substituted imidazole, imidazolium salts, phosphines, metal salts, triphenyl phosphine, alkyl-imidazole, and aluminum acetyl acetonate, iodonium compounds, onium salts and combinations thereof. For epoxy resins, curing agents such as multi-functional amines or alcohols can be optionally incorporated as cross-linking agents. Exemplary amines may include, but are not limited to ethylene diamine, propylene diamine, 1,2-phenylenediamine, 1,3-phenylene diamine, 1,4-phenylene diamine, and any other compounds containing 2 or more amino groups. Exemplary alcohols may include, but are not limited to, phenolic resins, Novolak systems, bisphenols, and any other compounds containing two or more hydroxyl groups, or others known to one of ordinary skill in the art.

Where acrylates are used, curing catalysts can be selected from, but are not limited to, cationic curing initiators such as iodonium compounds or onium salts, or radical cuing initiators such as peroxides or azo-compounds, or others known to one of ordinary skill in the art.

Where condensation-cure siloxane resins are used, an optional Lewis-acidic catalyst such as an organometallic tin compound (e.g. Sn(acetate)2) can be used.

Additionally, for addition curable silicone resins, catalysts include compounds containing Group 8-10 transition metals (i. e. ruthenium, rhodium, platinum, palladium) complexes. Preferably the catalyst for an addition curable silicone resin is a platinum complex. Preferred platinum complexes include, but are not limited-to, fine platinum powder, metal black, metal adsorbed on solid supports such as alumina, silica or activated carbon, choroplatinic acid, metal tetrachloride, metal compounds complexed with olefins or alkenyl siloxanes such as divinyltetramethyldisiloxanes and tetramethyltetravinylcyclotetrasiloxane, and combinations thereof.

Catalyst inhibitors can be added to modify the curing profile of addition curable silicone resins and to achieve desired shelf life for the composition. Suitable inhibitors include, but are not limited to, phosphine or phosphite compounds, sulfur compounds, amine compounds, isocyanurates, alkynyl alcohol, maleate and fumarate esters, and mixtures thereof, and other compounds known to those skilled in the art. Some representative examples of suitable inhibitors also include triallylisocyanurate, 2-methyl-3-butyn-2-ol, triphenylphosphine, tris(2,4-di-(tert)-butylphenyl)phosphite, diallyl maleate, diethyl sulfide and mixtures thereof.

Another aspect of the present invention includes methods for preparing the described composition. The method comprises the steps of: preparing a precursor comprising at least one of a liquid metal, liquid metal alloy, and combinations thereof mixed with an insulating solid filler; providing a curable resin, and optionally an adhesion promoter and catalyst; blending the precursor with the resin; providing at least one substrate; disposing the blended mix on the substrate; and curing the mix.

To achieve homogeneity in the pre-cure paste, it is preferable that the liquid metal is uniformly dispersed in the curable resin before the addition of solid particle fillers; or a portion of the solid particle fillers are added to the curable resin to form a flowable mixture, to which liquid metal is subsequently added and dispersed before adding the remaining filler; or a thorough mixing of liquid metal and filler is done before adding the curable resin. Alternatively, curable resin and solid particulate filler may be pre-mixed prior to addition of liquid metal followed by homogenization with a high speed mixer, a homogenizer or any other types of mixer know to those skilled in the art. The order of addition, or mixing, of the liquid metal, filler and resin is not critical to this aspect of the invention and any combination of these steps will provide the composition of the present invention.

The liquid composition is thoroughly mixed and blended into a thixotropic paste. The thixotropic paste is applied on a variety of heat generating and heat dissipating substrates including glass, metal, plastic, ceramic, semiconductor, electronic devices and combinations thereof. The mixture may be applied between two surfaces and cured in place to provide a thermal interface material. The preferred viscosity of the pre-cured composition is preferably less than about one million cps and more preferably less than about 300 kcps at room temperature. In one embodiment of the claimed invention, the thixotropic paste is further degassed and cured at a temperature about 120-150° C. In addition to a thixotropic paste, the present compositions may also be applied as grease, gel and phase change material formulations. Alternatively, the present compositions can be pre-formed into sheets or films and cut into any desired shape. In this embodiment, the compositions can advantageously be used to form thermal interface pads or films that are positioned between electronic components.

The curing process can be performed by any process known to those skilled in the art. Curing can be done by methods such as thermal cure, UV light cure, microwave cure, e-beam cure and combinations thereof. Curing typically occurs at a temperature in a range between about 20° C. and about 250° C., more typically in a range of about 50° C and about 150° C. Curing typically occurs at a pressure in a range between about 1 atmosphere (atm) and about 5 tons pressure per square inch, more typically in a range between about 1 atm and about 100 pounds per square inch (psi). In addition, curing may typically occur over a period in a range between about 30 seconds and about 5 hours, and more typically in a range between about 90 seconds and about 120 minutes. Optionally, the cured composition can be post-cured at a temperature in a range between about 120° C. and about 150° C. over a period of about 1 hour to about 4 hours. After cure, the composition provides an electrical resistance of greater than about 10⁸ ohm/cm and a dissipation factor of less than about 0.01, preferably less than about 0.001.

Another aspect of the present invention is the use of the composition as a thermal interface material (TIM) in a wide variety of electrical devices (components) such as computers, semiconductors, or any device where heat transfer between components is needed. In one embodiment, the electronic component includes a semiconductor chip as a heat generating, or producing, component. In such a case, the heat producing component can be a chip carrier, an area array package, a chip scale package, or other semiconductor packaging structure. In other embodiments, the semiconductor chip itself is the heat producing component.

Application of the present thermal interface compositions may be achieved by any method known in the art. Conventional methods include screen printing, stencil printing, syringe dispensing, pick-and-place equipment and pre-application to either the heat generating or heat dissipating unit.

While the present disclosure has provided details on how the present compositions may be utilized as thermal interface material in electronic devices, the compositions of the present disclosure may be applied in any situation where heat is generated and needs to be removed. For example, the compositions of the present disclosure may be utilized to remove heat from a motor or engine, to act as underfill material in a flip-chip design, as die attach in an electronic device, and in any other applications where efficient heat-removal is desired.

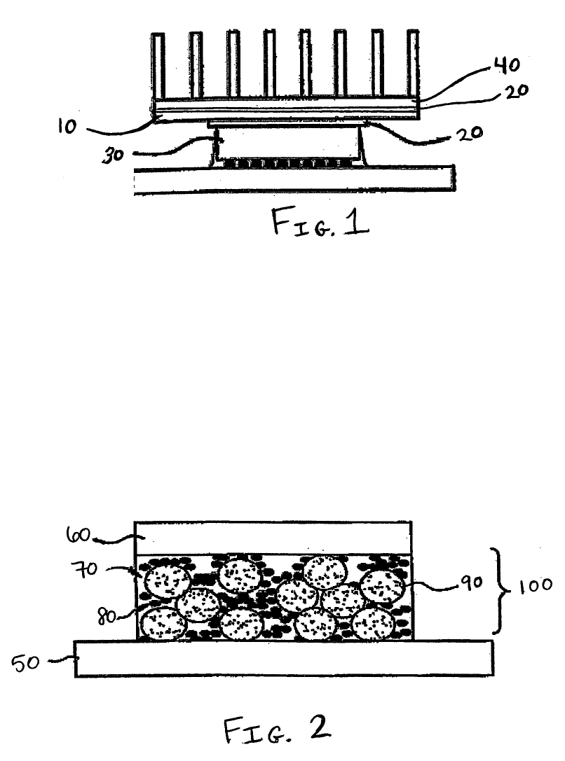

As shown schematically in FIG. 1, a thermal interface composition 20 can be interposed between a heat generating component 30 and a heat spreader (or heat dissipating) unit 10 to fill any air gaps and facilitate heat transfer. In this embodiment, the same or different thermal interface composition is aslo interposed between the heat spreader 10 and a heat sink 40. This Figure is not intending to be limiting, but to show one embodiment of the present invention.

FIG. 2 is a cross-section of a thermally conductive, electrically insulating TIM in accordance with the present disclosure. The TIM 100 is placed between an electronic device 50 and a heat sink/heat spreader 60. The TIM 100 is a polymeric resin 70, such as silicone based material, a liquid metal 80, such as gallium, and a particulate filler 90, such as aluminum oxide. The TIM fills any air gaps and facilitates heat transfer.

Methods for increasing heat transfer in accordance with the present disclosure include positioning a heat producing component in contact with a thermally conductive, electrically insulating thermal interface composition comprising a resin, a liquid metal and a particulate filler, and positioning a heat dissipating unit, such as a heat sink in contact with the thermal interface composition. The ratio of the liquid metal to particulate filler is about 2:1 to about 1:10. In an alternative embodiment, such as where the electronic component is a chip, the heat producing component may be placed in contact with a printed circuit board, and an electrical connection formed between the component and at least one electrical contact of the printed circuit board. A thermal interface composition, which includes a blend of a resin, liquid metal and particulate filler, is applied between the component and the print circuit board so that the thermal interface composition encapsulates the at least one electrical connection.

The following examples are included to illustrate the various features and advantages of the present invention, and are not intended to limit the invention.

### EXAMPLE 1

A commercial grade of addition curable polydimethylsiloxane, ECC 4865 (4.29 grams, GE Silicones) was used as the matrix material. About 18.98 grams of gallium (Aldrich, 99.999%) was melted in an oven at a temperature of about 50° C. and added to the silicone. After stirring and dispersing the gallium in silicone, about 3.72 grams of aluminum oxide (Sumitomo's AA04, average particle size 0.4 μm) and a further 17.81 grams of aluminum oxide (Showa Denko's AS20, average particle size 21 μm) were added in small portions with stirring to ensure proper mixing. In the final mixture, the resin to liquid metal to solid filler ratio is 1: 4.42 : 5.02 by weight. The flowable gray mixture was poured into a 50 mm circular mold, degassed at 50° C. for 1 hour and cured in a Carver press at 150° C., under a pressure of 5000 pounds retained for 45 minutes. The final gray disc was measured to be 2.50 mm in thickness, and determined to be electrically non-conductive using an Ohmmeter. Thermal conductivity was determined using a Holometrix TCA 300 instrument at 100° C. Viscosity was determined using a Brookfield cone and plate viscometer. The thermal conductivity was found to be 2.11 W/mK. The initial viscosity of the uncured formulation was 91,200±2000 cps at 2.5 rpm at room temperature.

### EXAMPLE 2

The formulation of Example 1 was repeated but with a different ratio of components: 4.06 grams of ECC4865 were used as the matrix material. 25.57 grams of gallium were mixed with ECC4865 first. The liquid mixture was then mixed with 4.46 grams of Al₂O₃ (Sumitomo's AA04, average particle size 0.4 μm) and about 21.37 grams of Al₂O₃ (Showa Denko's AS20, average particle size 21 μm). In the final mixture, the resin to liquid metal to solid filler ratio is 1:6.30:6.36 by weight. The final cured disc measured 1.61 mm in thickness, and was determined to be electrically non-conductive by an Ohmmeter. The thermal conductivity was outside the calibration range for the machine, but was estimated to be around 3.00 W/mK at 100° C. The initial viscosity of the uncured formulation was 208,000±2000 cps at 2.5 rpm at room temperature.

### EXAMPLE 3

The formulation of Example 1 was repeated but with a different ratio of components: About 3.58 grams of ECC4865 were used as the matrix material. About 19.50 grams of gallium were prepared with about 3.95 grams of Al₂O₃ (Sumitomo's AA04, average particle size 0.4 μm) and about 18.7 grams of Al₂O₃ (Showa Denko's AS20, average particle size 21 μm). In this instance, gallium was added last, and beading of gallium was observed. In the final mixture, the resin to liquid metal to solid filler ratio is 1:5.45:6.33 by weight. The final cured disc measured 2.58 mm in thickness, and was determined to be electrically non-conductive by an Ohmmeter. The sample underwent three thermal conductivity measurements at 100° C. which yielded an average value of about 2.75±0.01 W/mK. The initial viscosity of the uncured formulation was not measured.

### EXAMPLE 4

A base siloxane was prepared by mixing 20 grams of GE Silicones intermediate 81865, 5 grams of GE Silicones intermediate 88765, 1.7 g of GE Silicones intermediate 88104), 9.1 g of Gelest, Inc. intermediate DMSH03 and 0.85 g of GE Silicones intermediate 89174.

6.65 g of the above mixture was mixed with 19.60 grams of gallium, 4.90 grams of Al₂O₃ (Sumitomo's AA04, average particle size 0.4 μm), 27.60 grams of A1₂0₃ (Showa Denko's AS20, average particle size 21 μm) and 9.00 grams of Al₂O₃ (Showa Denko's AS40, average particle size 10 em). In the final mixture, the resin to liquid metal to solid filler ratio is 1:2.95:6.24 by weight. The final mixture was degassed at room temperature for 48 hours and cured in a Carver press at 150° C., 5000 pounds pressure for 40 minutes. The final cured disc measured 3.15 mm in thickness, and was somewhat uneven on one surface (Surface B). It was determined to be electrically non-conductive by an Ohmmeter. The sample underwent four thermal conductivity measurements at 100° C. The recorded thermal conductivity values were: 2.20 W/mK (Surface A facing up), 1.96 W/mK (Surface B facing up), 1.99 W/mK (surface B facing up) and 2.10 W/mK (surface A facing up). The viscosity of the uncured final formulation mixture was 330,600 cps at 2.5/s at room temperature.

### EXAMPLE 5

A base polymer matrix, C836-039-uv9380c, was prepared by mixing about 20 grams of methacryloxypropyltrimethoxysilane (MAPTMS), about 10 grams of acryloxy-capped polydimethylsiloxane polymer (DMSU22 obtained from Gelest) and about 0.63 grams of an iodonium cure catalyst (GE intermediate UV9380c). 5.50 grams of the above mixture was mixed first with 31.34 grams of Al₂O₃ (Showa Denko AS20, 21 μm), and then with 16.95 grams of gallium. Beading occurred. To this mixture, 0.16 g additional C836-039-uv9380c was added, and after proper mixing a smooth thixotropic mixture resulted. 2.50 grams of Al₂O₃ (Showa Denko AS20, 21 μm) was added to the final mixture to give a final formulation consisting of 5.66 grams of base polymer matrix, 16.95 grams of gallium and 33.84 grams of Al₂O₃ in a wt. ratio of 1:2.99:5.98 (polymer: gallium: solid filler). The mixture was degassed at 40° C. for 1 hour and cured in a Carver press at 150° C., under a pressure of 5000 pounds for 45 minutes. The final cured disc measured 3.30 mm in thickness and was determined to be electrically non-conductive by an Ohmmeter. Two thermal conductivity measurements were completed on the sample at 100° C. yielding an average value of 3.18±0.05 W/mK. The initial viscosity of the uncured formulation was not measured.

### EXAMPLE 6

ECC4865 was mixed with appropriate amounts of gallium-indium-tin alloy (62 wt % Ga: 25 wt % In: 13 wt % Sn, Indium Corporation of America) to form an emulsion. Alumina was added to the mixture in small portions with stirring. The mixture was degassed at room temperature for 3-12 hours and cured at 150 ° C., under a pressure of 5000 pounds for 45-60 minutes. The results of a batch composition in preparing thermally conductive adhesives containing a combination of these liquid metals and solid particles are listed in Table 1. The viscosity was measured by a rheometer.

TABLE 1

| | | | Thermal | | Dissipation | |
|---|---|---|---|---|---|---|
| | | Alumina (g) | conductivity | | factor | Permittivity |
| | Ga/In/Sn | (x:y | (100° C. | Viscosity(cps, | (10 kHz/100 | (10 kHz/100 |
| ECC4865(g) | (g) | AS40: AA04) | W/mK) | 2.5 /s, r.t.) | Hz) | Hz) |
| 4.00 | 0 | 32.13 (4:1) | 2.18 ± 0.05 | 88,400 | 0.0001 | 5.96/ |
| | | | | | /0.0030 | 5.98 |
| 4.00 | 12.28 | 24.62 (4:1) | 2.04 ± 0.03 | 74,300 | 0.0012 | 9.31/ |
| | | | | | /0.0024 | 9.35 |
| 4.00 | 16.44 | 22.35 (4:1) | 2.27 ± 0.04 | 69,500 | 0.0008/ | 10.95/ |
| | | | | | 0.0019 | 10.98 |
| 4.00 | 19.95 | 19.92 (4:1) | 2.21 ± 0.07 | 41,200^{a} | 0.0008/ | 11.29/ |
| | | | | | 0.0021 | 11.29 |
| 4.00 | 0 | 32.08 (1:0) | 1.96 ± 0.04 | 214,000 | N/A | N/A |
| 4.03 | 12.35 | 24.60 (1:0) | 2.01 ± 0.04 | 213,000 | N/A | N/A |
| 4.04 | 16.71 | 22.26 (1:0) | 1.99 ± 0.05 | 163,000 | N/A | N/A |
| 4.09 | 20.37 | 20.37 (1:0) | 1.88 ± 0.04 | 124,000 | N/A | N/A |
| 4.00 | 0 | 32.07 (6:1) | 1.89 ± 0.04 | 163,000 | N/A | N/A |
| 4.00 | 12.27 | 24.58 (6:1) | 1.99 ± 0.04 | 153,000 | N/A | N/A |
| 4.00 | 16.42 | 22.11 (6:1) | 1.85 ± 0.04 | 98,500 | N/A | N/A |
| 4.00 | 19.96 | 19.94 (6:1) | 1.96 | 72,900 | N/A | N/A |
| 4.01 | 12.83 | 25.32 (6:1) | 2.08 | 130,000 | N/A | N/A |
| 4.00 | 16.32 | 21.77 (6:1) | 1.89 | N/A | N/A | N/A |
| 4.00 | 19.10 | 19.10 (6:1) | 1.73 | N/A | N/A | N/A |

^{a}Measured using a Brookfield viscometer at 2.5 rpm at room temperature.

### EXAMPLE 7

Liquid metal (61% Ga, 25% In, 13% Sn and 1% Zn from Indium Corporation of America) was added to commercial silicone adhesive TSE3281g from GE Toshiba in the amounts specified below. The liquid metal was uniformly dispersed into the silicone adhesive first by hand mixing and then with a Speedmixer at 900 rpm for 5 seconds. Qualitatively, the final mixtures had similar flowability as the control TSE3281G. In C1014-1-a, the ratio of the polymer matrix to liquid metal to solid fillers is 1:1.02:5.49 by weight. In C1014-1-b, the ratio of the polymer matrix to liquid metal to solid fillers is 1:3.25:5.49 by weight. 3-layer sandwiched structures consisting of silicon-TIM-aluminum were built using these adhesives with an assembly pressure of 10 or 50 psi. Force was applied for no longer than 3 seconds at the prescribed pressure. The adhesives were cured between the silicon and aluminum coupons at 150° C. for 2 hours under no external pressure. Four sandwiched structures were built for each adhesive under each prescribed pressure. The thermal diffusivities of the sandwiched complexes were measured using Microflash 300 (Netzsch Instruments), and the in-situ thermal resistances were calculated using manufacturer-provided macros. As shown in Table 2, lower thermal resistance and thereby better in-situ thermal performance were obtained with formulations containing liquid metal and assembly pressures of 50 psi. At 10 psi assembly pressures, i. e. pressures that would be more practical in industry, formulations containing sufficient amounts of liquid metal, C1014-1b, also showed better in situ thermal performance than formulations without liquid metal, while maintaining similar flowability and processibility.

TABLE 2

| | | | | Thermal | Average |
|---|---|---|---|---|---|
| | | | | Resistance | Thermal |
| | | | Bond Line | Range | Resistance |
| | | | thickness | (mm²− | (mm²− |
| | Sample ID | Description | (mil) | K/W) | K/W) |
| 1 | 3278-99-1 | Remixed | 2.68 ± 0.23² | 59 - 69² | 63 ± 42 |
| | | TSE3281g | 2.25 ± 0.45³ | 55 - 61³ | 57 ± 33 |
| 2 | C1014-1-a | TSE3281g + | 2.76 ± 0.44² | 56 - 73² | 66 ± 8² |
| | | liquid metal¹ | 2.03 ± 0.10³ | 46 - 53³ | 49 ± 3³ |
| | | (6.35:1 wt) | | | |
| 3 | C1014-1-b | TSE3281g + | 2.69 ± 0.48² | 53 - 56² | 54 ± 2² |
| | | liquid metal¹ | 2.17 ± 0.08³ | 45 - 52³ | 48 ± 3³ |
| | | (2:1 wt) | | | |

¹Liquid metal is 61% Ga, 25% In, 13% Sn and 1% Zn from Indium Corporation of America; TSE3281g is a silicone adhesive containing ˜84.6 wt % alumina.
²assembly pressure = 10 psi, sample size = 4
³assembly pressure = 50 psi, sample size = 4.0 mm

While typical embodiments have been set forth for the purpose of illustration, the foregoing description should not be deemed to be a limitation on the scope of the invention. Accordingly, various modifications, adaptations, and alternatives may occur to one skilled in the art without departing from the spirit and scope of the present invention.

1. A composition comprising a liquid metal, a particulate filler, and a resin, wherein said liquid metal and particulate filler are present in a ratio of about 2:1 to about 1:10.

2. The composition of claim 1, wherein the liquid metal is selected from the group consisting of gallium, indium, mercury, metallic glasses, and alloys and combinations and mixtures thereof.

3. The composition of claim 2, wherein the liquid metal is selected from the group consisting of gallium, gallium alloys, and mixtures thereof.

4. The composition of claim 1, wherein the particulate filler is selected from the group consisting of metal oxides, metal nitrides, coated metallic particles, and coated ceramic particles.

5. The composition of claim 1, wherein the particulate filler is selected from the group consisting of aluminum oxide, aluminum nitride, boron nitride, graphite, carbon nanotubes, diamond, magnesium oxide, zinc oxide, zirconium oxide, titanium oxide, chromium oxide, silica coated aluminum nitride, glass coated silver, alumina coated silver, alumina coated aluminum and combinations and mixtures thereof.

6. The composition of claim 1, wherein said particulate filler is aluminum oxide.

7. The composition of claim 1, wherein said resin comprises at least one of silicone resin, epoxy resin, acryloxy resin, and combinations and mixtures thereof.

8. The composition of claim 7, wherein said resin comprsises a silicone resin and said silicone resin is an addition curable silicone resin.

9. The composition of claim 1 further comprising an adhesion promoter.

10. The composition of claim 9 wherein the adhesion promoter is selected from the group consisting of alkoxysilanes, aryloxysilanes, alkoxysiloxane, and aryloxysiloxane.

11. The composition of claim 1, wherein the liquid metal and particulate filler are present in a combined amount of about 20 to about 95 weight %.

12. The composition of claim 11, wherein the liquid metal and particulate filler are present in a combined amount of about 60 to about 95 weight %.

13. The composition of claim 1 further comprising a catalyst.

14. An electronic component comprising the composition of claim 1.

15. A composition comprising a liquid metal selected from the group consisting of gallium, gallium alloys, and mixtures thereof, an aluminum oxide particulate filler, and a silicone resin, wherein said liquid metal and particulate filler are present in a ratio of about 2:1 to about 1:10.

16. A method of increasing heat transfer comprising the steps of
positioning a heat producing component in contact with a thermal interface composition comprising a liquid metal, a particulate filler, and a resin, wherein said liquid metal and particulate filler are present in a ratio of about 2:1 to about 1:10; and
positioning a heat dissipating unit in contact with the thermal interface composition.

17. The method according to claim 16, wherein the step of positioning the heat dissipating unit in contact with a thermal interface composition comprises positioning a heat dissipating unit selected from the group consisting of heat spreaders, heat sinks, lids, and heat pipes.

18. The method according to claim 16, wherein the step of positioning heat producing component in contact with a thermal interface composition further comprises positioning a thermal interface composition selected from the group consisting of pre-formed sheets, films and greases in contact with the heat producing component.

19. The method according to claim 16, wherein said liquid metal is selected from the group consisting of gallium, indium, mercury, metallic glasses, and combinations thereof.

20. The method according to claim 16, wherein said particulate filler comprises thermally conducting materials selected from the group consisting of aluminum oxide, aluminum nitride, boron nitride, diamond, graphite, carbon nanotubes, magnesium oxide, zinc oxide, zirconium oxide, titanium oxide, chromium oxide, silica coated aluminum nitride, glass coated silver, alumina coated silver, alumina coated aluminum and combinations and mixtures thereof.

21. The method according to claim 20, wherein said particulate filler is aluminum oxide.

22. The method according to claim 15, wherein said curable resin is selected from the group consisting of a silicone resin, epoxy resin, acryloxy resin, and combinations and mixtures thereof.

23. An electronic component comprising a heat producing component, a heat dissipating component, and a thermal interface composition interposed between the heat producing component and the heat dissipating unit, the thermal interface composition comprising a liquid metal, a particulate filler, and a resin, wherein said liquid metal and particulate filler are present in a ratio of about 2:1 to about 1:10.

24. The electronic component of claim 23, wherein said liquid metal is selected from the group consisting of gallium, indium, mercury, metallic glasses, and combinations thereof.

25. The electronic component of claim 24, wherein said particulate filler comprises thermally conducting materials selected from the group consisting of aluminum oxide, aluminum nitride, boron nitride, diamond, graphite, carbon nanotubes, magnesium oxide, zinc oxide, zirconium oxide, titanium oxide, chromium oxide, silica coated aluminum nitride, silica coated silver, alumina coated silver, alumina coated aluminum and combinations and mixtures thereof.

26. The electronic component of claim 23, wherein said resin comprises at least one of silicone resin, epoxy resin, acryloxy resin, and combinations and mixtures thereof.
